(19) United States
(12) Patent Application Publication
(10) Pub. No.: US 2008/0101879 A1
(43) Pub. Date: May 1, 2008

(54) SPADE-TYPE BIT

(76) Inventor: LaVerne R. Durfee, Harmony, NC (US)

Correspondence Address: Dennis J. Williamson;Moore & Van Allen, PLLC, P.O. Box 13706, Research Triangle Park, NC, 27709, US

(21) Appl. No.: 11/554,801

(22) Filed: Oct. 31, 2006

(51) Int. Cl. B23B 51/00

(52) U.S. Cl. 408/214

(57) ABSTRACT

The bit has a longitudinally extending shank having a quick release connection formed at one end thereof for attachment to a driving tool such as a drill. The opposite end of the shank is formed with a cutting member. The cutting member is formed as a twisted planar member having a generally helical shape. A screw tip is provided along the longitudinal axis of the bit for guiding the bit through the workpiece.

The invention relates generally to drill bits and more particularly to an improved bit construction for a spade-type drill bit.

### BACKGROUND OF THE INVENTION

Rotary drill bits for boring holes of preselected diameters in a workpiece are known. Such bits come in a variety of styles such as twist bits, fluted bits, augers and the like. One type of bit is known as a spade bit or paddle bit. This type of bit includes a shank that has one end adapted to be releasably connected to a chuck of a rotary tool such as a drill or driver. The opposite end of the shank supports a cutting member where the cutting member has a substantially flat, relatively thin face formed as a paddle or spade. The width of the cutting member is selected such that the bit bores a hole of predeteremined diameter.

The cutting member is typically formed with a first cutting edge and a second cutting edge arranged substantially perpendicular to the direction of movement of the bit through the workpiece. The cutting member may also be formed with a pilot point along its longitudinal axis that has a sharpened edge for guiding the bit into and through the workpiece. The first and second cutting edges may be formed with spurs at the ends thereof to create a clean edge to the hole.

While such drill bits are known an improved spade bit that bores a cleaner, faster hole is desired.

### SUMMARY OF THE INVENTION

The bit of the invention has a longitudinally extending shank having a quick release connection formed at one end thereof for attachment to a driving tool such as a drill. The opposite end of the shank is formed with a cutting member. The cutting member is formed as a twisted planar member having a generally helical shape. In one embodiment the twist angle is approximately 30 degrees. A screw tip is provided along the longitudinal axis of the bit for guiding the bit through the workpiece.

### BRIEF DESCRIPTION OF THE DRAWINGS

FIG. 1 is a plan view of an embodiment of the drill bit of the invention.

FIG. 2 is a side view of the drill bit of FIG. 1.

FIG. 3 is an end view of the drill bit of FIG. 1.

FIG. 4 is a detailed view of an embodiment of the screw tip used on the drill bit of the invention.

### DETAILED DESCRIPTION OF EMBODIMENTS OF THE INVENTION

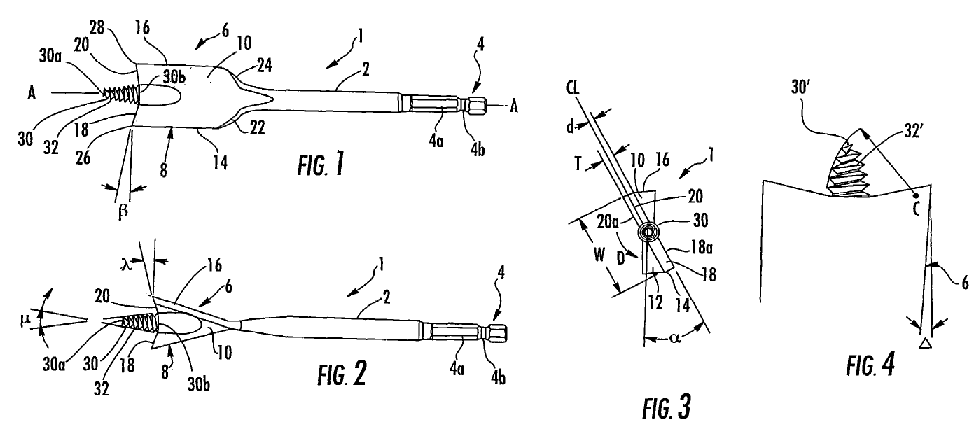

Referring to FIGS. 1 through 3 the drill bit of the invention is shown generally at 1 and consists of an elongated shank 2 having a longitudinal axis A-A. A quick release coupling 4 is formed at one end of the shank 2. The quick release coupling may comprise a hex portion 4a having an annular recess 4b formed therein that can be engaged and retained by the chuck of a rotary driving tool such as a drill or power driver. The opposite end of shank 2 is connected to a cutting member 6. In one embodiment the shank 2 and cutting member 6 may be formed of a single piece of material such as hardened steel.

Cutting member 6 is comprised of a member 8 having a first face 10 and a second face 12 arranged substantially parallel to the first face 10. A pair of side edges 14 and 16 are arranged generally parallel to one another and to the longitudinal axis A-A. In one embodiment a relief angle Δ may be provided where the side edges 14 and 16 angle inwardly toward the longitudinal axis A-A from the end of the bit toward shank 2 as best shown in FIG. 4. The relief angle Δ may be between 1 and 15 degrees. The cutting member 6 is arranged such that the width W of the cutting member is significantly greater than the thickness T of the cutting member such that the bit 1 has a generally spade-bit shape. The member 8 comprises a planar member that is twisted about longitudinal axis A such that the cutting member 6 has a generally helical shape and extends around the longitudinal axis in an arc through its entire length. The cutting member 6 is helically shaped from the cutting shoulders 18 and 20 to the opposite edges 22 and 24 proximate the shank 2 to create smooth curved faces 10 and 12.

A twist angle α of up to 45 degrees provides performance benefits in the drill bit of the invention because the blade allows for the rapid and efficient ejection of chip swarf from the hole being drilled. The twist angle as used herein is the angle between one of the cutting edges (e.g. cutting edge 18a) and the opposite edge (e.g. edge 22) of the face creating that edge (e.g. face 10) about the longitudinal axis A. In one embodiment the cutting member 6 has a twist angle α of approximately 30 degrees, as best shown in FIG. 3.

The cutting shoulders 18 and 20 are formed at the end of cutting member 6 and extend from side edges 14 and 16, respectively, toward the longitudinal axis A. The cutting edges are arranged at an oblique angle β of up to 20 degrees with a preferred angle of approximately 10 degrees relative to a line perpendicular to longitudinal axis A such that sharp scribing corners 26 and 28 are formed on cutting shoulders 18 and 20, respectively, that have an included angle of between approximately 80 to 90 degrees. Shoulders 18 and 20 are formed with beveled surfaces that define cutting edges 18a and 20a. Cutting edge 18a is formed as an acute rake angle λ between shoulder 18 and face 10 such that cutting edge 18a is formed as sharp edge that contacts the workpiece as the drill bit is turned in the direction of arrow D. Shoulder 20 and face 12 are arranged in the same manner to create a similarly sharp cutting edge 20a. In one embodiment rake angle λ is between 5 and 25 degrees and is preferably 18 degrees. The cutting edges 18a and 20a are offset (d) from the centerline CL of the cutting member 6 extending through longitudinal axis A-A as best shown in FIG. 3.

The cutting shoulders 18 and 20 extend to the base 30b of pilot screw 30 where pilot screw 30 is arranged along the longitudinal axis A-A. Pilot screw 30 is generally conically shaped decreasing in diameter from shoulders 18 and 20 to point 30a. The pilot screw 30 includes tapered threads 32 that extend upwardly from base 30b that maintain equal thread pitch along the length of pilot screw 30. In a preferred embodiment, the point of the pilot screw 30 defines an included angle μ of 24 degrees although angles within a range of 15 to 35 degrees can also be used. An alternate embodiment of the tip is shown in FIG. 4 where the threads 32′ of the screw tip 30′ are arranged on an arc of a circle centered on point C.

Specific embodiments of an invention are described herein. One of ordinary skill in the art will recognize that the invention has other applications in other environments. In fact, many embodiments and implementations are possible. The following claims are in no way intended to limit the scope of the invention to the specific embodiments described above.

1. A spade bit comprising:
a shank having a longitudinal axis and a cutting member located at a distal end thereof, said cutting member being helically shaped and extending around the longitudinal axis in an arc and an axially extending pilot screw, said pilot screw defining a threaded member, said threaded member having a base attached to the cutting member and a point where threads extend from the base to the point on a cone having an angle of between approximately 15 and 35 degrees.

2. The spade bit of claim 1 wherein said cutting member has a generally uniform thickness.

3. The spade bit of claim 1 wherein said cutting member has a pair of generally straight outer edges.

4. The spade bit of claim 1 wherein said cutting member includes cutting edges that are offset from a centerline through the center of the longitudinal axis of said shank.

5. The spade bit of claim 4 wherein said cutting edges extend in an oblique angle from the edges of said cutting member towards said pilot crew.

6. The spade bit of claim 1 wherein said cutting member extends helically less than 90 degrees about said longitudinal axis.

7. A spade bit comprising:
a shank having a longitudinal axis;
a pilot screw extending generally axially from said shaft and defining a screw thread having a base and a point; and
a cutting member mounted to said shaft having opposing faces and outer edges, said cutting member extending helically about at least a circumferential portion of said longitudinal axis, said cutting member defining a helix angle of approximately 30 degrees about the longitudinal axis, said cutting member defining forward cutting edges that are inclined relative to the longitudinal axis.

8. The spade bit of claim 7 wherein said cutting edges connect with said base.

9. The spade bit of claim 7 wherein the included angle of said pilot screw is between 15 degrees and 35 degrees.

10. The spade bit of claim 7 wherein the rake angle of said cutting edges is between 5 and 25 degrees.

11. The spade bit of claim 7 wherein the forward cutting edges define a scribing corner with an outer edge of each blade, said scribing corners defining an included angle of less than 90 degrees.

12. The spade bit of claim 11 wherein each scribing corner defines a an angle of approximately 80 degrees.

13. The spade bit of claim 7 wherein said cutting member extends helically less than 90 degrees about said shaft.

14. A spade bit for mounting to a power drill apparatus, said spade bit comprising:
a shank having a longitudinal axis, a chuck mounting end and a cutting end;
a cutting member defined on an extending along said shank at said cutting end, said cutting member being twisted helically around at least a circumferential portion of said shank approximately 30 degrees, the cutting member forming a plurality of generally straight cutting edges inclined relative to the longitudinal axis of the shank; and
a pilot screw extending from said cutting member and defining a screw thread wherein the included angle of the threaded member is between 15 degrees and 35 degrees;
said helical configuration of said cutting member being adapted to eject chip swarf axially outwardly from said bore during a boring operation.

15. The spade bit of claim 14 wherein said cutting edges extend at an oblique angle to a plane defined perpendicularly to said shaft.

16. The spade bit of claim 14 wherein said cutting member includes a pair of generally straight outer edges that extend at an angle to the longitudinal axis.

17. The spade bit of claim 14 wherein the relief angle of each of the cutting edges is between 5 and 25 degrees.

18. The spade bit of claim 14 wherein each of the cutting edges defines a scribing corner with an outer edge of the blade, each of said scribing corners defining an included angle of less than 90 degrees.

19. A spade bit comprising:
a shank having a longitudinal axis and a cutting member located at a distal end thereof, said cutting member having a pair of faces, said cutting member being helically shaped and extending around the longitudinal axis such that each of said pair of faces is helically shaped for the entire extent thereof and an axially extending pilot screw, said pilot screw defining a screw thread and said cutting member defining a forward cutting edge.
